(19) United States
(12) Patent Application Publication
(10) Pub. No.: US 2007/0286021 A1
(43) Pub. Date: Dec. 13, 2007

(54) One Touch Data Acquisition

(75) Inventors: Scott T. Hoenmans, Arvada, CO (US); Martin C. Williams, Boulder, CO (US)

Correspondence Address: PAUL S MADAN;MADAN, MOSSMAN & SRIRAM, PC, 2603 AUGUSTA DRIVE, SUITE 700, HOUSTON, TX, 77057-5662, US

(73) Assignee: INPUT/OUTPUT, INC., Houston, TX (US)

(21) Appl. No.: 11/760,122

(22) Filed: Jun. 8, 2007

Related U.S. Application Data
(60) Provisional application No. 60/812,467, filed on Jun. 10, 2006.

(51) Int. Cl. G01V 1/00

(52) U.S. Cl. 367/56

(57) ABSTRACT

A seismic spread has a plurality of seismic stations positioned over a terrain of interest and a controller programmed to automate the data acquisition activity. In one aspect, the present disclosure provides a method for forming a seismic spread by developing a preliminary map of suggested locations for seismic devices and later forming a final map having in-field determined location data for the seismic devices. Each suggested location is represented by a virtual flag used to navigate to each suggested location. A seismic device is placed at each suggested location and the precise location of the each placed seismic devices is determined by a navigation device. The determined locations are used to form a second map based on the determined location of the one or more of the placed seismic devices. Using the virtual flag eliminates having to survey the terrain and place physical markers and later remove those physical markers. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims. (37 CFR 1.72(b)

### CROSS-REFERENCE TO RELATED APPLICATIONS

This application claims the benefit of and takes priority from U.S. Provisional application 60/812,467 filed on Jun. 10, 2006, which is hereby incorporated herein by reference. This Application is related to U.S. patent application Ser. No. 10/664,566, file on Sep. 17, 2003 title “Single Station Wireless Seismic Data Acquisition Method and Apparatus,” which is hereby incorporated by reference for all purposes.

### BACKGROUND OF THE DISCLOSURE

Oil companies conduct seismic surveying to lower risk and to reduce costs of locating and developing new oil and gas reserves. Seismic surveying is, therefore, an up front cost with intangible return value. Consequently minimizing the cost of seismic surveying and getting quality results in minimum time are important aspects of the seismic surveying process.

Seismic surveys are conducted by deploying a large array of seismic sensors over a terrain of interest. These arrays may cover over 50 square miles and may include 2000 to 5000 seismic sensors. An energy source such as buried dynamite may discharged within the array to impart a shockwave into the earth. The resulting shock wave is an acoustic wave that propagates through the subsurface structures of the earth. A portion of the wave is reflected at underground discontinuities, such as oil and gas reservoirs. These reflections are then sensed at the surface by the sensor array and recorded as seismic data. Such sensing and recording are referred to herein as seismic data acquisition. This seismic data is then processed to generate a three dimensional map, or seismic image, of the subsurface structures. The map may be used to make decisions about drilling locations, reservoir size and pay zone depth. Usually a surveying crew is used to locate the planned position of sensors on the ground prior to laying out the acquisition equipment. A backpack global positioning system (GPS) receiver is then used by the surveyor and stakes are planted in the ground at each of thousands of predetermined sensor locations. Therefore, array deployment in the typical system is a two-step process adding time and labor costs to the seismic survey process.

Moreover, traditional seismic surveys typically involve numerous visits to field locations. Often, the layout of field equipment requires multiple trips for flagging, re-surveying and re-flagging, and finally equipment layout. After shooting concludes, a traditional survey crew must not only retrieve the equipment from the field, but they must also cleanup the area, removing all visual markers, which requires more time and effort, whether done during the pickup trip or, as is often the case, by making supplementary trips through the field. These repetitive time- and resource-consuming activities are not only expensive but can jeopardize a survey's completion given strict time constraints, such as seasons/weather or permit expirations.

The present disclosure addresses these and other shortcomings of convention seismic data acquisition techniques.

### SUMMARY OF THE DISCLOSURE

In one aspect, the present disclosure provides a method for forming a seismic spread by developing a preliminary map of suggested locations for seismic devices and later forming a final map having in-field determined location data for the seismic devices. The term seismic devices means any device that is used in a seismic spread, including, but not limited to, sensors, sensor stations, receivers, transmitters, power supplies, control units, etc. In one embodiment, each suggested location is represented by a virtual or electronic flag that personnel use to navigate to each of the suggested locations. That is, this flag resides digitally in a computer rather than physically on the terrain. The suggested locations can be a point and/or a range. At or near each suggested location, the crew places a seismic device. At the time of placing the seismic device, the precise location of the each placed seismic devices is determined by a navigation device such as a GPS device in the seismic device and/or a hand-held device. The determined location can be recorded using an X ordinate, a Y ordinate, and/or a Z ordinate. The determined locations are used to form a second map based on the determined location of the one or more of the placed seismic devices.

It should be understood that examples of the more important features of the disclosure have been summarized rather broadly in order that detailed description thereof that follows may be better understood, and in order that the contributions to the art may be appreciated. There are, of course, additional features of the disclosure that will be described hereinafter and will form the subject of the claims appended hereto.

### BRIEF DESCRIPTION OF THE DRAWINGS

The novel features of this disclosure, as well as the disclosure itself, will be best understood from the attached drawings, taken along with the following description, in which similar reference characters refer to similar parts, and in which:

FIG. 1 represents a cable seismic data acquisition system;

FIG. 2 schematically illustrates a wireless seismic data acquisition system;

FIG. 3A shows a schematic representation of the system of FIG. 2 in more detail;

FIG. 3B shows one embodiment of a wireless station unit having an integrated seismic sensor;

FIG. 4 is a flow chart illustrating one methodology for deploying a seismic data acquisition system according to the present disclosure; and

FIG. 5 is one exemplary system for performing the methodology shown in FIG. 4.

### DETAILED DESCRIPTION OF THE DISCLOSURE

In aspects, the present disclosure relates to devices and methods for controlling activities relating to seismic data acquisition. The present disclosure is susceptible to embodiments of different forms. There are shown in the drawings, and herein will be described in detail, specific embodiments of the present disclosure with the understanding that the present disclosure is to be considered an exemplification of the principles of the disclosure, and is not intended to limit the disclosure to that illustrated and described herein.

The methods and devices of the present disclosure may be utilized with any type of seismic data acquisition system wherein seismic devices are positioned over a terrain of interest according to a desired survey plan. For context, the equipment and components of two such systems are discussed below.

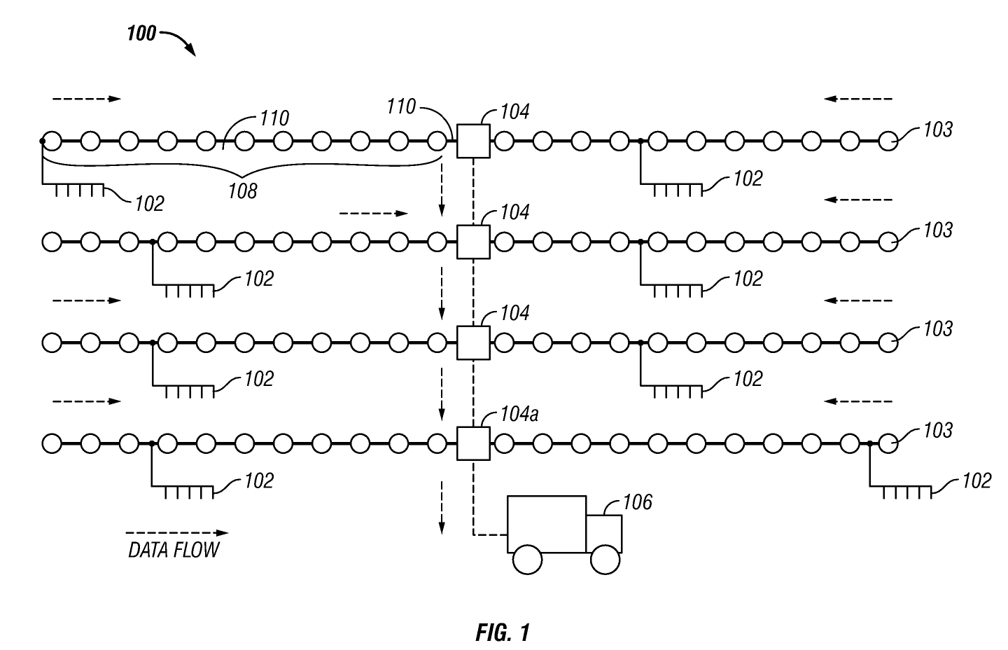

FIG. 1 depicts a typical cable-based seismic data acquisition system 100. The typical system 100 includes an array (string) of spaced-apart seismic sensor units 102. Each string of sensors is typically coupled via cabling to a data acquisition device (field box) 103, and several data acquisition devices and associated string of sensors are coupled via cabling 110 to form a line 108, which is then coupled via cabling 110 to a line tap or (crossline unit) 104. Several crossline units and associated lines are usually coupled together and then to a central controller 106 housing a main recorder (not shown). One sensor unit 102 that is in use today is a velocity geophone used to measure acoustic wave velocity traveling in the earth. Other sensor unit 102 that may be used are acceleration sensors (accelerometers) for measuring acceleration associated with the acoustic wave. Each sensor unit may comprise a single sensor element or more than one sensor element for multi-component seismic sensor units.

The sensors 102 are usually spaced at least on the order of tens of meters, e.g., 13.8-220.0 feet. Each of the crossline units 104 may perform some signal processing and then store the processed signals as seismic information for later retrieval. The crossline units 104 are each coupled, either in parallel or in series with one of the units 104a serving as an interface with between the central controller 106 and all crossline units 104.

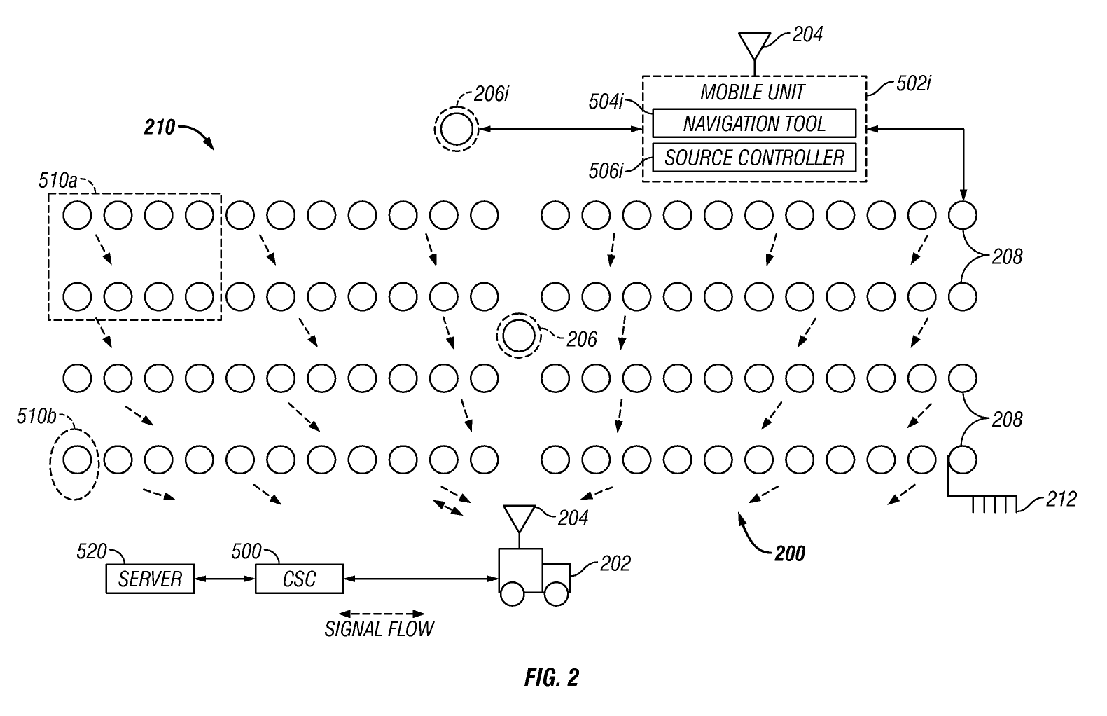

Referring to FIG. 2 there is schematically shown a wireless seismic data acquisition system. The system 200 includes a central controller 202 in direct communication with each of a number of wireless sensor stations 208 forming an array (spread) 210 for seismic data acquisition. Each sensor station 208 includes one or more sensors 212 for sensing seismic energy. Direct communication as used herein refers to individualized data flow as depicted in FIG. 2 by dashed arrows. The data flow may be bi-directional to allow one or more of: transmitting command and control instructions from the central controller 202 to each wireless sensor station 208; exchanging quality control data between the central controller 202 and each wireless sensor station 208; and transmitting status signals, operating conditions and/or selected pre-processed seismic information from each wireless sensor station 208 to the central controller 202. The communication may be in the form of radio signals transmitted and received at the central controller 202 via a suitable antenna 204. The term “seismic devices” includes any device that is used in a seismic spread, including, but not limited to, sensors, sensor stations, receivers, transmitters, power supplies, control units, etc.

The system 200 may operate in a passive mode by sensing natural or random seismic energy traveling in the earth. The system 200 may operate in an active mode using a seismic energy source 206, e.g., pyrotechnic source, vibrator truck, compressed gas, etc., to provide seismic energy of a known magnitude and source location. In many applications, multiple seismic energy sources may be utilized to impart seismic energy into a subterranean formation. A representative seismic energy source is designated with numeral 206i. Typically, activation (or more commonly, “shooting” or “firing”) of the source 206i is initiated locally by a mobile unit 502i. In one embodiment, the mobile unit 502i includes a human operator who may utilize a navigation tool 504i to navigate to a source 206i and a source controller 506i to fire the source 206i. To navigate the terrain and to determine precise location coordinates, the navigation tool 504i may be equipped with a global positioning satellite device (GPS device)and/or a database having predetermined coordinates (e.g., z coordinates).

The controller 202, the central station computer (CSC) 500 and a central server 520 exert control over the constituent components of the system 200 and direct both human and machine activity during the operation of the system 200. As discussed in greater detail below, the CSC 500 automates the shooting of the sources 206i and transmits data that enables the sensor stations 208 to self-select an appropriate power usage state during such activity. The server 520 can be programmed to manage data and activities over the span of the seismic campaign, which can include daily shooting sequences, updating the shots acquired, tracking shooting assets, storing seismic data, pre-processing seismic data and broadcasting corrections. Of course, a single controller can be programmed to handle most if not all of the above described functions. For example, the CSC 500 can be positioned in or integral with the controller 202. Moreover, in some applications it may be advantageous to position the controller 202 and CSC 500 in the field, albeit in different locations, and the server 520 at a remote location.

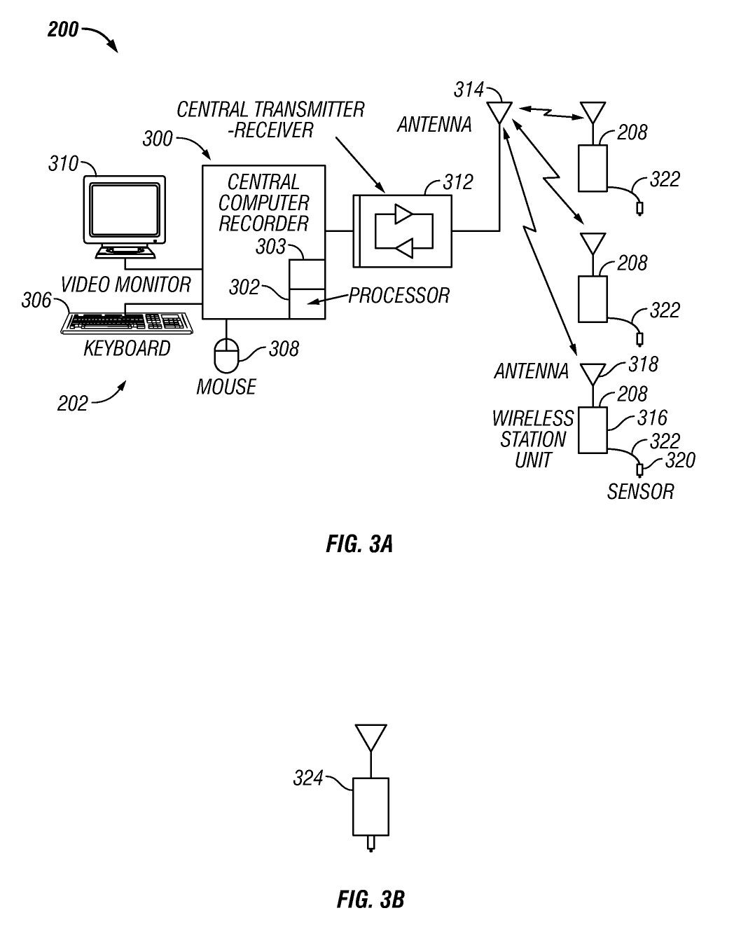

FIG. 3A is a schematic representation of the system 200 in more detail. The central controller 202 includes a computer 300 having a processor 302 and a memory 303. An operator can interface with the system 200 using a keyboard 306 and mouse or other input 308 and an output device such as a monitor 310. Communication between remotely-located system components in the spread 210 and the central controller 202 is accomplished using a central transmitter-receiver (transceiver) unit 312 operably connected to the central controller 202 along with an antenna 314.

The central controller 202 communicates with each wireless sensor station 208. Each wireless sensor station 208 shown includes a wireless station unit 316, an antenna 318 compatible with the antenna 314 used with the central controller 202, and a sensor unit 320 responsive to acoustic energy traveling in the earth co-located with a corresponding wireless sensor station. Co-located, as used herein, means disposed at a common location with one component being within a few feet of the other. Therefore, each sensor unit 320 can be coupled to a corresponding wireless station unit by a relatively short cable 322, e.g., about 1 meter in length, or coupled by integrating a sensor unit 320 with the wireless station unit 316 in a common housing 324 as shown in FIG. 3B.

Location parameters (e.g., latitude, longitude, elevation, azimuth, inclination, etc.) associated with a particular wireless sensor station help to correlate data acquired during a survey. These parameters determined prior to a survey using an expected sensor location and nominal sensor orientation and the parameters can be adjusted according to the present disclosure. The location parameters are stored in a memory either in the central controller 202, in the sensor station 208 or elsewhere. In one embodiment, the wireless sensor station 208 includes a global positioning system (GPS) receiver (not shown) and associated antenna (not shown). The GPS receiver in such an embodiment can be coupled to an appropriately programmed processor and to a clock to provide location parameters such as position and location data for correlating seismic information and for synchronizing data acquisition. Alternatively, location parameters can be transmitted to and stored in the central controller and synchronization may be accomplished by sending signals over the VHF/UHF radio link independent of the GPS. Therefore, the on-board GPS can be considered an optional feature of the disclosure. Location parameters associated with sensor orientation can be determined by accelerometers and/or magnetic sensors and/or manually.

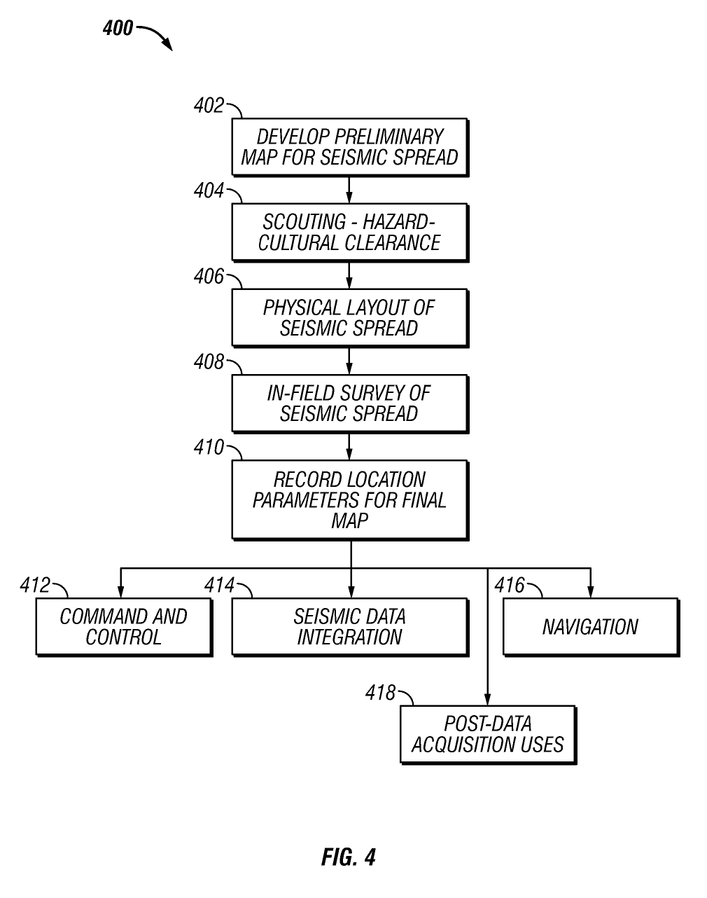

Referring now to FIG. 4, there is shown an exemplary methodology 400 for deploying the above-described seismic data acquisition system. As will be appreciated, the method 400 deploys a suite of field equipment in a manner that reduces the time and resources required to obtain a seismic survey. The use of the above-described renewable seismic devices, some of which are positionally aware, as opposed to physical visual markers, eliminates the need for field survey, staking/flagging, and field clean-up steps. Thus, during a given seismic data acquisition campaign, the seismic devices are in effect “touched” only once for placement, and touched only “once” for retrieval.

Initially, at step 402, a preliminary map is prepared that indicates locations for each sensor station or other device. A term map, as used herein, refers to a collection of data representative of the indicated locations of the seismic devices. Of course, the map can include other data as well. The data can be in graphical or tabular format, a model utilizing mathematical relationships, or any other suitable structure. In one embodiment, the preliminary map provides suggested locations for the seismic devices. The crew or mobile units utilize a suggested location as a guide to make an in-field decision on the final location for the seismic device. Thus, the crew has flexibility to autonomously pick a favorable location for each seismic device. That is, the crew can be provided with a set of guidelines, constraints, restrictions and other decision-influencing criteria that forms a microenvironment within which the seismic device can be placed. The suggested location for each seismic device is represented as a separate virtual or electronic flag or layout marker. That is, this flag resides digitally in a computer rather than physically on the terrain. The suggested location can be a point such as an X,Y coordinate or an area such as an area within a circle having a specified radius from an X,Y coordinate. The electronic layout markers can be compiled to form the preliminary map that resides in a computer accessible database. As will become apparent, these electronic flags or layout markers replace the wooden stakes, flags, paint or other physical objects that conventionally is used to identify seismic device locations. In some embodiments, the preliminary plan is a pre-plan as that term is understood in the art.

At step 404, a survey crew scouts a geographical area at which the seismic survey will be conducted. Initially, the survey crew inspects the suggested locations, along with the surrounding area, to note hazardous conditions, whether natural or human-made. Generally speaking, these include areas where exclusion rules apply due to Health, Safety, and Environment (HSE) issues. The suggested locations are revised as needed to maintain a safe distance from any found hazardous condition. Thereafter, the survey crew performs a cultural clearance for the suggested locations. This clearance can include inspections for any situations or conditions that could impact or violate legal boundaries, regulatory rules, permits, contractual agreements and other such restrictions. Again, the suggested locations are revised if needed to ensure compliance with any applicable rules, guidelines or agreements. Because these inspections do not involve planting flags or other like activities that disturb the landscape, it should be appreciated that even after these preliminary scouting activities, the terrain has been “untouched.”

At step 406, mobile units 206i utilize the electronic layout flags or markers to navigate to the suggested locations for the seismic devices. It should be appreciated that because the layout markers are electronic, these layout markers cannot be washed away, stolen or otherwise moved from their original position. Thus, there is a higher likelihood that the mobile units 206i will plant the seismic devices proximate to the suggested locations. It should be appreciated that in contrast to conventional surveying operations, the method 400 eliminates the need for a survey crew to add physical survey devices such as sticks or paint to the terrain before planting the seismic devices.

At step 408, location parameters (e.g., latitude, longitude, azimuth, inclination, etc.) are determined for the actual location at which each seismic device has been placed. In one embodiment, these parameters are determined by the mobile units 504i using a GPS receiver. Other parameters might be determined with a manual compass used by the crew or by one or more magnetometers in the sensor unit. Parameters might also be determined using multi-component accelerometers for determining orientation of the planted sensor unit. In another embodiment, a GPS receiver, accelerometers, magnetometers, and/or other sensors disposed in sensor unit, e.g., the station or sensor unit or both, determine the location parameters.

At step 410, the in-field determined location parameters are transferred to the sensor stations, to a memory module carried by a mobile unit, and/or a memory module positioned at a central or remote location. These in-field determined location parameters can be transmitted immediately or recorded in a suitable memory module for later retrieval and transmission. Suitable transfer arrangements include wireless transmission media and wire media such as data cables. In certain embodiments, the location parameters are entered automatically upon system activation and sensor station.

It will be appreciated that method 400 reduces the steps necessary to conduct field operations for a seismic survey. After completing the scouting and hazard steps, this method omits visual markers, e.g., flags, stakes, paint, and thereby eliminates the need for personnel to performing field surveys and flagging for each location. Often, a conventional field survey and flagging processes require repeating, as visual markers are easily moved or destroyed by external elements. Utilizing the preliminary map, together with data obtained from LiDAR, full-feature/terrain feature imaging, aerial photos, slope and vegetation analysis, DEM creation, allows concurrent field surveying and layout of seismic devices.

These in-field determined location parameters can used to form a final map for the various seismic devices making up the seismic spread. This final map, which contains precise in-field determined coordinates for the seismic devices, can be used to control subsequent seismic data acquisition activities and /or used in connection with a geographical information system that creates stores, analyzes, and manages spatial data and associated attributes. In some embodiments, the final plan is a post-plot as that term is understood in the art. For example, at step 412, the seismic grid can be used to control the shooting sequence and power usage for the seismic spread. In another example, at step 414, the in-field determined location parameters can be included in a navigation database used in connection with “heads-up” navigation. In still another example, at step 416, the in-field determined location parameters can be integrated or correlated with acquired seismic data. Furthermore, at step 418, the in-field location parameter can be used even after completion of the seismic acquisition campaign. For example, the in-field parameter can be used in connection with any subsequent seismic data acquisition activities, during drilling of wellbores, for characterizing the subterranean formation, and other like applications.

Thus, from the above, one skilled in the art will appreciate that embodiments of the present disclosure utilize an equipment layout process requiring only one visit to place seismic devices and an equipment pickup process requires only one visit to retrieve the seismic devices. Survey marker placement visits and survey marker cleanup visits are not needed. Exemplary advantages arising from the teachings of the present disclosure include cost reductions and reduced health, safety, and environment risks. The risk reduction is based in part on reduced number of crew required, reduced number of tasks crew must perform, and reduced total time spent in field. Other advantages include reduced cost due to elimination of permit renewal/reapplication fees resulting from schedule overruns.

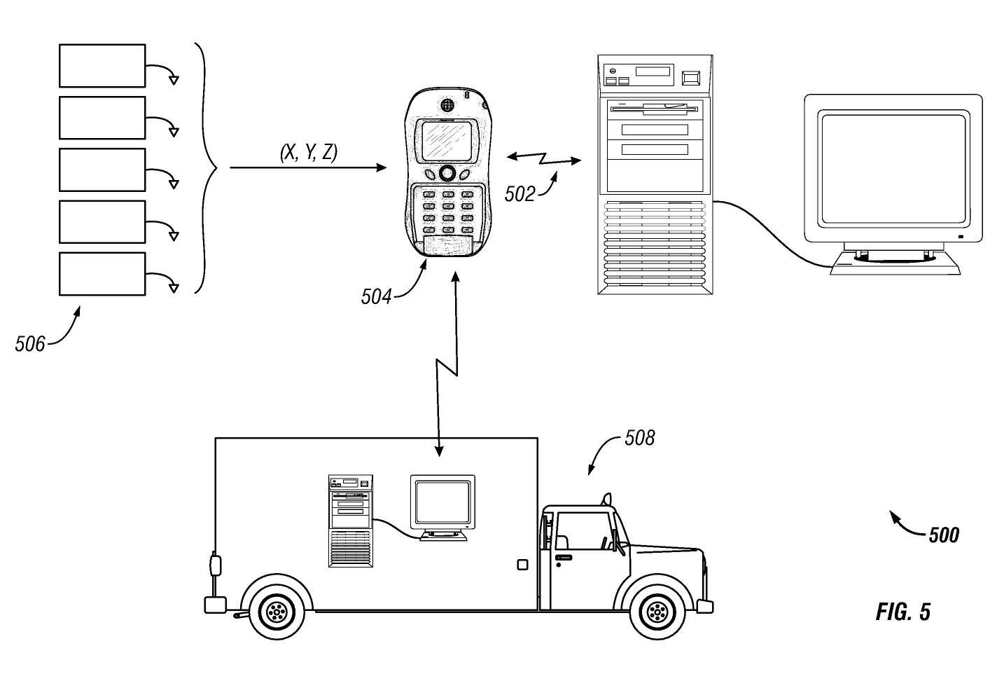

Referring now to FIG. 5, there is shown an illustrative system 500 for executing the method shown in FIG. 4. The system 500 includes a computer 502 utilized to prepare the preliminary survey plan, one or more navigation tools 504 that may be used to determine location parameters for seismic devices 506 in the field, and a mobile server 508 that may be utilized to update the preliminary survey plan and develop one or more datasets, databases, knowledge bases, and other information sets for managing the seismic survey campaign. The server 508 may, of course, be the same as the computer 502.

The computer 502 may be programmed with known software such as a MESA design package and other known seismic survey plan development software and be provided with data such as historical seismic data, (Geographical Information Services) G IS data, and other such knowledge bases. The computer 502 provides a preliminary plan that includes suggested location parameters for seismic equipment 506, such as seismic stations and sources. Field crew convey the seismic equipment 506 and the navigation tool 504 into the area to be surveyed. At the suggested locations, the field crew positions the seismic equipment 506 at or near the suggested location parameter for each piece of seismic equipment 506 and use a location sensor that may be in the navigation tool 504, such as a GPS device or other sensor for deterring a location parameter, to determine precise location parameters for each piece of seismic equipment 506. Thus, location data is obtained at about the same time that the seismic equipment 506 is positioned in the field. The navigation tool 504 may record the location parameters and thereafter furnish the recorded location parameters to the mobile server 508. The mobile server 508 may utilize the received data from the navigation tool 504 for the several purposes shown in blocks 412, 414, 416, and 418 shown in FIG. 4 or for other uses.

Furthermore, while the present disclosure has been discussed in the context of seismic data acquisition, it should be understood that the teachings of the present disclosure can be advantageously applied to any situation that involve complex flow of data and interaction between multiple personnel that are tasked with collecting, recording, processing and transmitting information.

The foregoing description is directed to particular embodiments of the present disclosure for the purpose of illustration and explanation. It will be apparent, however, to one skilled in the art that many modifications and changes to the embodiment set forth above are possible without departing from the scope of the disclosure. It is intended that the following claims be interpreted to embrace all such modifications and changes.

What is claimed is:

1. A method for forming a seismic spread, comprising:
forming a first map of a seismic spread that suggests a location for each of one or more seismic devices within a geographical area of interest;
placing the one or more seismic devices at a location proximate to the suggested location for each of one or more of the seismic devices; and
determining the location of the one or more of the placed seismic devices at a time proximate to the placing of the one or more seismic devices; and
forming a second map based on the determined location of the one or more of the placed seismic devices.

2. The method of claim 1 wherein the first and second maps include at least X,Y coordinates for each seismic device.

3. The method of claim 1 further comprising electronically flagging one or more of the suggested locations.

4. The method of claim 3 further comprising navigating to the one or more suggested locations using the electronic flags.

5. The method of claim 1, wherein the determined location includes at least one of: an X ordinate, a Y ordinate, and a Z ordinate.

6. The method of claim 1, wherein the suggested location is one of (i) a point, and (ii) a range.

7. The method of claim 1 wherein the location of the one or more of the placed seismic devices is determined by a GPS device positioned at one of: (i) the one or more placed seismic device, and (ii) a hand-held device.

8. The method of claim 1 wherein the determined location is transmitted to a processor by one of: (i) the one or more placed seismic devices, and (ii) a hand-held device.

9. The method of claim 1 wherein the processor is at one of: (i) a central controller, (ii) a mobile server, and (iii) a stationary server.

10. A system for conducting a seismic survey, comprising:
(a) a computer forming a first map of a seismic spread that suggests a location for each of one or more seismic devices within a geographical area of interest;
(b) a navigation tool for deterring a location parameter for each of the one or more seismic devices in the geographical area of interest, the navigation tool receiving at least a portion of the first map from the computer; and
(c) a mobile server receiving the determined location parameters from the navigation tool and updating the first map based on the received determined locations.

11. The system of claim 1 0 wherein the first map include at least X,Y coordinates for each seismic device.

12. The system of claim 10, wherein the determined location parameter includes at least one of: an X ordinate, a Y ordinate, and a Z ordinate.

13. The system of claim 10, wherein the computer suggests a location by providing one of (i) a point, and (ii) a range.
